(19) United States
(12) Patent Application Publication
(10) Pub. No.: US 2020/0018226 A1
(43) Pub. Date: Jan. 16, 2020

(54) VARIABLE TYPE SUPERCHARGER

(71) Applicants: Hyundai Motor Company, Seoul (KR); Kia Motors Corporation, Seoul (KR)

(72) Inventor: Jin-Kook KONG, Suwon-si (KR)

(73) Assignees: Hyundai Motor Company, Seoul (KR); Kia Motors Corporation, Seoul (KR)

(21) Appl. No.: 16/365,477

(22) Filed: Mar. 26, 2019

(30) Foreign Application Priority Data
Jul. 11, 2018 (KR) 10-2018-0080453

(51) Int. Cl. F02B 37/16; F02B 39/06; F02B 39/12; F02D 23/00

(52) U.S. Cl. CPC F02B 37/16; F02D 23/005; F02B 39/12; F02B 39/06

(57) ABSTRACT

A variable type supercharger may include a first pulley receiving power from an engine, a planetary gear set connected to the first pulley, a gear portion engaged to the planetary gear set, a second pulley receiving power from the engine to transmit the power to the gear portion, a motor connected to the gear portion and transmitting power to the gear portion, and a compressor connected to the planetary gear set to receive power from the planetary gear set.

### CROSS-REFERENCE TO RELATED APPLICATION

The present application claims priority to Korean Patent Application No. 10-2018-0080453 filed on Jul. 11, 2018, the entire contents of which is incorporated herein for all purposes by this reference.

### BACKGROUND OF THE DISCLOSURE

### Field of the Disclosure

The present invention relates to a variable type supercharger which operates a compressor by an engine and a motor, and more particularly, a variable type supercharger which operates the compressor according to an engine speed to improve performance and efficiency.

### Description of Related Art

Generally, a vehicle draws outside air, and then mixes the introduced air with fuel in an appropriate ratio to burn it in an engine.

In a process of generating the power by driving the engine, it is necessary to supply the external air sufficiently for the combustion so that the desired output and the combustion efficiency may be obtained, and a turbocharger has been used as a device configured for supercharging combustion air to increase the combustion efficiency of the engine.

Furthermore, there is a supercharger which is excellent in response at the initial stage of vehicle starting. The supercharger is disposed between an air cleaner and a carburetor and supplies a large amount of drawn in air to the cylinder to increase the output of the internal combustion engine. In most internal combustion engines, the fuel amount which may be burned in the cylinder is determined by the air amount being drawn in. If more mixed air is supercharged into the cylinder, it can generate more power of about 30-50% at the same speed.

FIG. 1 is a schematic view of a conventional supercharger.

Referring to FIG. 1, an engine 111 and a pulley 121 are connected by a belt 123 and the pulley 121 is connected to a planetary gear set including a sun gear 131, a carrier 132 and a ring gear 133.

The pulley 121 is connected to the ring gear 133 of the planetary gear set, the compressor 141 is connected to the sun gear 131 of the planetary gear set, and the carrier 131 of the planetary gear set is connected to the motor 151.

In the present configuration, the motor 151 adjusts the speed of the carrier 132 according to the engine speed to obtain the target speed of the compressor 141.

The conventional supercharger connects the engine, motor and compressor to the planetary roller and adjusts the motor speed according to the engine RPM to obtain the speed of the compressor. At low speed, the engine speed is low and the compressor is driven by the motor so that the capacity of the motor should be large. Therefore, there is a drawback difficult to apply to 12 v systems.

On the other hand, if the capacity of the motor is reduced, there is a limitation in raising the rotation speed of the compressor in the low speed in the 12 v system, and the motor capacity in the 48 v system is increased but there is a problem that the cost is large.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a variable type supercharger in which boosting by an engine instead of a motor is made in the low and middle speed of the engine, and as the engine speed increases, the drive power of the motor is increased to generate the boosting in the middle and high speed, improving the performance and reducing the capacity of the motor.

A variable type supercharger according to an exemplary embodiment of the present invention may include a first pulley receiving power from an engine, a planetary gear set connected to the first pulley, a gear portion engaged to the planetary gear set, a second pulley receiving power from the engine to transmit the power to the gear portion, a motor connected to the gear portion and transmitting power to the gear portion, and a compressor connected to the planetary gear set to receive power from the planetary gear set.

The first pulley may be connected to a carrier of the planetary gear set.

A clutch may be provided between the second pulley and the gear portion.

The clutch may be turned on or off depending on the rotation speed of the compressor.

The first pulley may transmit power to a carrier of the planetary gear set and the second pulley may transmit power to a ring gear of the planetary gear set through the gear portion when the clutch is turned on.

The first pulley may transmit power to a carrier of the planetary gear set and the motor may transmit power to a ring gear of the planetary gear set through the gear portion when the clutch is turned on.

A sun gear of the planetary gear set may be connected to the compressor.

A bypass valve may be mounted in a branch passage of an air inflow passage connected to the compressor.

The bypass valve may be opened when the rotation speed of the compressor is greater than a target boost.

A variable type supercharger according to various exemplary embodiments of the present invention may include a first pulley receiving power from an engine, a planetary gear set connected to the first pulley, a gear portion engaged to the planetary gear set, a second pulley receiving power from the engine to transmit the power to the gear portion, and a motor connected to the gear portion and transmitting power to the gear portion, wherein a sun gear of the planetary gear set may be connected to a brake so that engine starting is possible by the motor.

The sun gear of the planetary gear set may be connected to a compressor.

An air inflow passage may be connected between the compressor and the brake.

In accordance with a variable type supercharger according to an exemplary embodiment of the present invention, the variable type supercharger generates boosting by the pulley connected to an engine instead of a motor in the low and middle speed, and generates boosting by the driving torque of the motor increased in the middle and high speed, improving the performance thereof and reducing the capacity of the motor by the present configuration.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view of a conventional supercharger;

FIG. 2 is a schematic view of a variable type supercharger according to an exemplary embodiment of the present invention;

FIG. 3 is a schematic view showing the speed of planetary gear set of the variable type supercharger according to the exemplary embodiment of the present invention shown in FIG. 2;

FIG. 4 is a schematic view showing the speeds of the engine and compressor of the variable type supercharger according to the exemplary embodiment of the present invention;

FIG. 5 is a schematic view of a bypass valve of the variable type supercharger according to the exemplary embodiment of the present invention; and

FIG. 6 is a schematic view of a variable type supercharger according to various exemplary embodiments of the present invention.

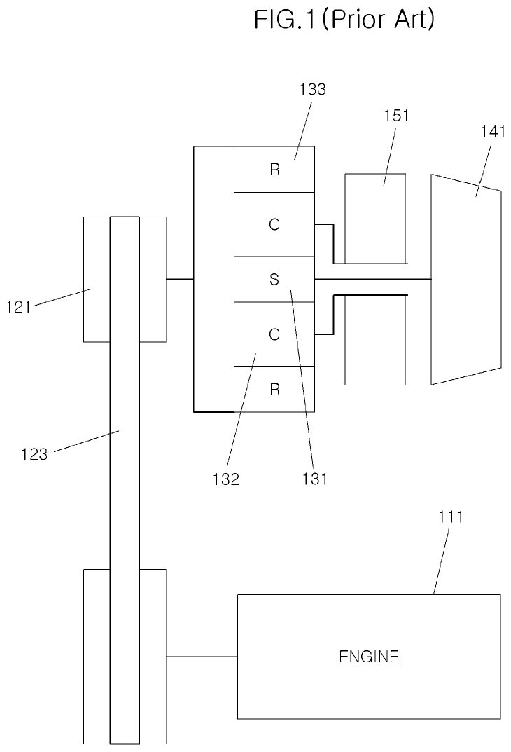

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

When any constituent element is referred to as being connected or connected to other constituent elements, it may be understood that any constituent element may be directly connected or connected to the other constituent elements, but there may be another constituent elements in therebetween.

Furthermore, the term “connection” as used herein means a direct connection or indirect connection between a member and another member, and may refer to all physical connections such as bonding, attachment, fastening, bonding, and coupling.

Also, expressions such as “first, second”, etc. Are used only to distinguish a plurality of configurations, and do not limit the order or other features between configurations.

The singular forms “a” and “the” include a plurality of expressions unless the context clearly dictates otherwise. The word “comprise” or “having” is used to mean that there is a feature, a number, a step, an operation, a constituent element, a part or a combination thereof described in the specification, and it is to be understood that one or more other features, numbers, steps, operations, elements, parts, or combinations thereof may be added.

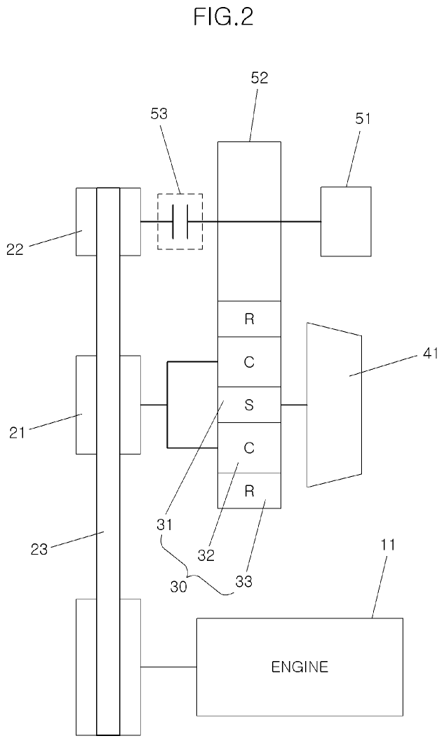

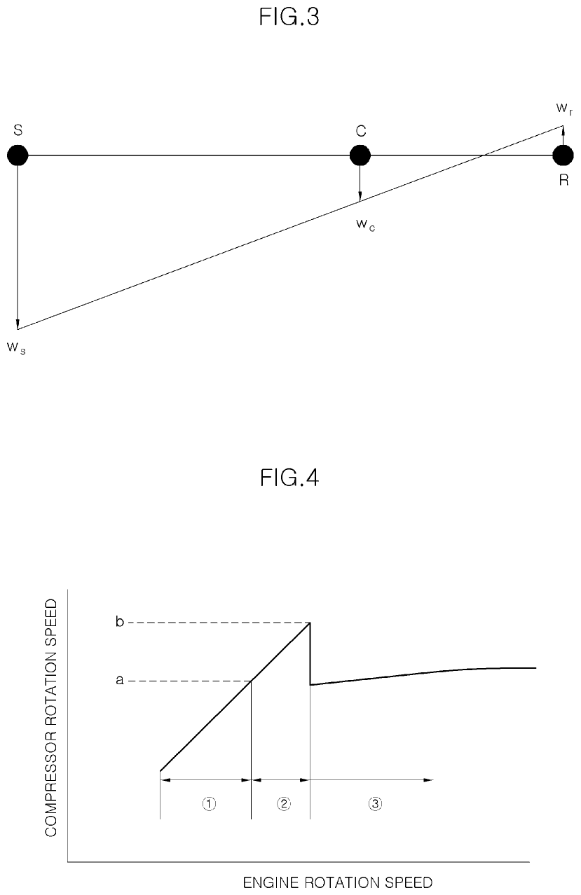

FIG. 2 is a schematic view of a variable type supercharger according to an exemplary embodiment of the present invention, and FIG. 3 is a schematic view showing the speed of planetary gear set of the variable type supercharger according to the exemplary embodiment of the present invention shown in FIG. 2.

Referring to FIG. 2 and FIG. 3, the variable type supercharger may include a first pulley 21 receiving power from an engine 11, a planetary gear set 30 connected to the first pulley 21, a gear portion 52 connected to the planetary gear set 30, a second pulley 22 that receives power from the engine 11 and transmits the power to the gear portion 52, a motor 51 that transmits power to the gear portion 52, and a compressor 41 which is connected to the planetary gear set 30 to receive power.

In accordance with various aspects of the present invention, the first pulley 21 may be connected to a carrier 32 of the planetary gear set 30 and a clutch 53 may be provided between the second pulley 22 and the gear portion 52.

Herein, the first pulley 21 and second pulley 22 may be connected to the engine 11 through a belt 23 to transmit the power of the engine 11.

In an exemplary embodiment of the present invention, a clutch 53 may be turned on or off according to the rotation speed of the compressor 41, where when the clutch 53 is turned on, the first pulley 21 transmits power to the carrier 32 of the planetary gear set 30 and the second pulley 22 transmits power to the ring gear 33 of the planetary gear set 30 through the gear portion 52.

In an exemplary embodiment of the present invention, a controller is connected to the clutch 53 to control the on/off of the clutch 53.

Alternatively, when the clutch 53 is turned off, the first pulley 21 transmits power to the carrier 32 of the planetary gear set 30 and the motor 51 transmits power to the ring gear 33 of the planetary gear set 30 via the gear portion 52.

That is, when the clutch 53 is turned on, the rotating directions of the ring gear 33 and the carrier 32 become opposite directions to each other and the rotation speed of the compressor 41 connected to the sun gear 31 is increased.

As such, when the speed of the compressor 41 reaches the maximum speed, the clutch is turned off, the motor 51 rotates the ring gear 33 of the planetary gear set 30 through the gear portion 52, and the motor 51 and the ring gear 33 rotate the ring gear 33 in the opposite direction to the rotating direction of the motor 51.

On the other hand, ωr represents the speed of the second pulley 22, ωc represents the speed of the first pulley 21, and ωs represents the speed of the compressor 41. The engine RPM increases to increase mechanical work by the engine and reduce electric work of the motor, reducing the capacity of motor.

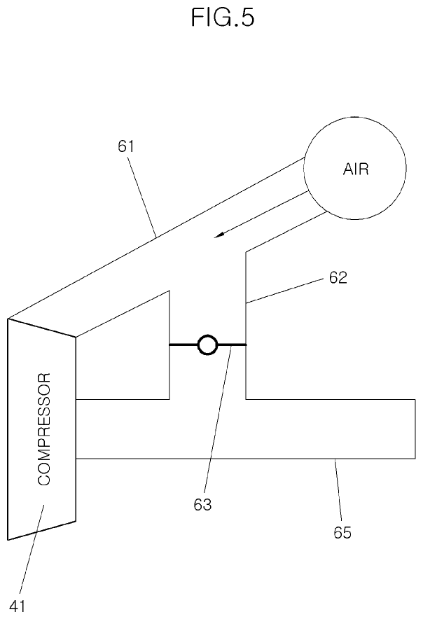

FIG. 4 is a schematic view showing the speeds of the engine and compressor of the variable type supercharger according to the exemplary embodiment of the present invention, and FIG. 5 is a schematic view of a bypass valve of the variable type supercharger according to the exemplary embodiment of the present invention.

Referring to FIG. 4, the point a may be the rotation speed of the compressor at which the target boost is produced by the engine and the point b may be the maximum a rotation speed of the compressor allowed by the engine in the system.

Referring to FIG. 5, the sun gear of the planetary gear set may be connected to the compressor 41 and a bypass valve 63 may be connected to a branch flow passage 62 of an air inflow passage 61 of the compressor 41.

In an exemplary embodiment of the present invention, the controller is connected to an actuator of the bypass valve 63 to control the opening amount of the bypass valve 63.

The bypass valve 63 may be opened when the rotation speed of the compressor 41 is greater than the target boost so that the air of the air inflow passage may be expelled to an air outlet passage 65 connected to the branch flow passage 62.

Describing the operation mechanism of the motor and the compressor according to the clutch on/off, the clutch is turned on and the motor does not work in \textcircled{1} section in the graph of FIG. 4, but it is desirable to assist the operation of the second pulley, and the second pulley operates the compressor to generate boosting.

Next, in \textcircled{2} section of the graph, the clutch is turned on and the motor does not operate, but the pulley operates the compressor to generate boosting, and the rotation speed of the compressor is greater than the rotation speed of the target boost, and in the instant case, the bypass valve is opened to adjust the boost.

In \textcircled{3} section of the graph, the clutch is turned off and the motor operates to rotate the ring gear of the planetary gear set, and the compressor is rotated by the mechanical work of the first pulley and the electric work of the motor.

At the instant time, the engine RPM is higher than middle speed where the work down by the first pulley becomes larger and the work done by the motor becomes lower, so that the motor functions as an assistant to adjust the rotation speed of the compressor.

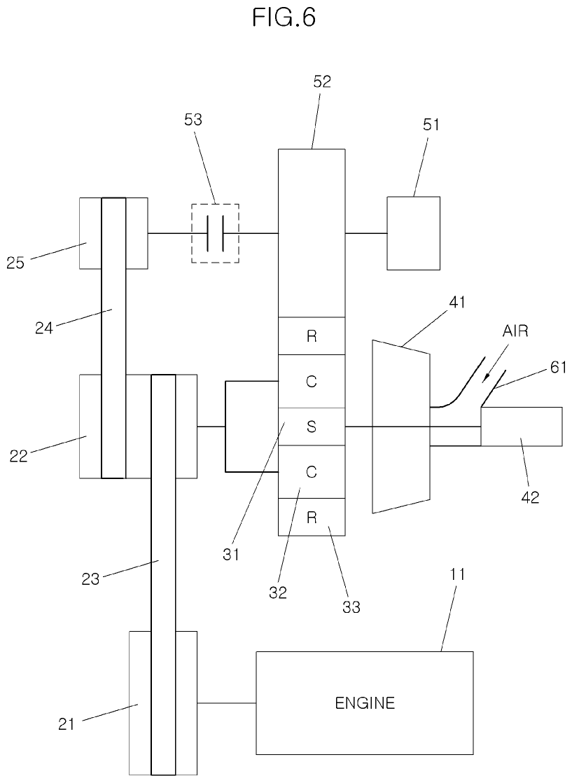

FIG. 6 is a schematic view of a variable type supercharger according to various exemplary embodiments of the present invention.

Referring to FIG. 6, a variable type supercharger is configured to include a first pulley 21 connected to an engine 11, a second pulley 22 receiving power from the engine 11 through a first belt 23, a planetary gear set 30 connected to the second pulley 22, a gear portion 52 connected to the planetary gear set 30, a third pulley 25 receiving power from the engine 11 through the second belt 24 to transmit the power to the gear portion 52, and a motor 51 transmitting power to the gear portion 52. The sun gear 31 of the planetary gear set 30 is connected to a brake 42, so that engine starting is possible by the motor 51.

The sun gear 31 of the planetary gear set 30 may be connected to a compressor 41 and an air inflow passage 61 may be connected between the compressor 41 and the brake 42.

In an exemplary embodiment of the present invention, the controller is connected to an actuator of the brake 42 to control the operation of the brake 42 and to the clutch 53 to control the operation of the clutch 53.

Therefore, the variable type supercharger according to an exemplary embodiment of the present invention may improve the performance by causing the boosting through the engine operation instead of the motor in the low and middle speed, and by causing the boosting by increasing the driving torque of the motor in the middle and high speed, and provide an effect of reducing the capacity of the motor by the present configuration.

Those of ordinary skill in the art to which the present invention belongs may understand that the present invention may be practiced in other specific forms without departing from the spirit or essential characteristics thereof.

It may therefore to be noted that the exemplary embodiments described above are provided by selecting and presenting the most exemplary embodiments to assist the understanding of the person skilled in the art among the various possible examples and the technical idea of the present invention is not limited only by the exemplary embodiment, but various changes, additions and alterations are possible within the range not departing from the technical idea of the present invention, and it will be appreciated that other equivalent embodiments are possible.

The scope of the present invention is defined by the following claims rather than the detailed description, and all changes or modifications derived from the meaning and range of the patent claims and the concept of equivalence may be interpreted as included within the scope of the present invention.

Furthermore, inventors are defined as a term or word used in the exemplary embodiment and claims range based on the principle that the concept of a term may be properly defined to describe its disclosure in its best form, and it may not be construed to be limited to only the ordinary or dictionary meaning.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A variable type supercharger comprising:
a first pulley receiving power from an engine;
a planetary gear set connected to the first pulley;
a gear portion engaged to the planetary gear set;
a second pulley coupled to the first pulley and receiving the power from the engine to transmit the power to the gear portion;
a motor connected to the gear portion and transmitting power thereof to the gear portion; and
a compressor connected to the planetary gear set to receive power from the planetary gear set.

2. The variable type supercharger of claim 1, wherein the first pulley is connected to a carrier of the planetary gear set.

3. The variable type supercharger of claim 1, wherein a clutch is mounted between the second pulley and the gear portion.

4. The variable type supercharger of claim 3, wherein the clutch is configured to be turned on or off depending on a rotation speed of the compressor.

5. The variable type supercharger of claim 4, further including a controller configured to control operation of the clutch.

6. The variable type supercharger of claim 3,
wherein a ring gear of the planetary gear set is engaged to the gear portion, and
wherein the first pulley transmits the power of the engine to a carrier of the planetary gear set and the second pulley transmits the power of the engine to the ring gear of the planetary gear set through the gear portion when the clutch is turned on.

7. The variable type supercharger of claim 3,
wherein a ring gear of the planetary gear set is engaged to the gear portion, and
wherein the first pulley transmits the power of the engine to a carrier of the planetary gear set and the motor transmits the power thereof to the ring gear of the planetary gear set through the gear portion when the clutch is turned off.

8. The variable type supercharger of claim 1, wherein a sun gear of the planetary gear set is connected to the compressor.

9. The variable type supercharger of claim 8, wherein a bypass valve is mounted in a branch passage of an air inflow passage connected to the compressor, the branch passage being connected to an air outflow passage.

10. The variable type supercharger of claim 9, wherein the bypass valve is configured to be opened when a rotation speed of the compressor is greater than a target boost.

11. The variable type supercharger of claim 10, further including a controller configured to control operation of the bypass valve.

12. The variable type supercharger of claim 1, further including a belt coupling the engine, the first pulley and the second pulley.

13. A variable type supercharger comprising:
a first pulley receiving power from an engine;
a planetary gear set, a first rotation element of which is connected to the first pulley;
a gear portion engaged to a second rotation element of the planetary gear set;
a second pulley coupled to the first pulley and receiving the power from the engine to transmit the power to the gear portion; and
a motor connected to the gear portion and transmitting a power thereof to the gear portion;
wherein a third rotation element of the planetary gear set is connected to a brake so as to start of the engine by the power of the motor.

14. The variable type supercharger of claim 13, wherein the first rotation element, the second rotation element and the third rotation element of the planetary gear set is a carrier, a ring gear, and a sun gear, respectively.

15. The variable type supercharger of claim 14, wherein the sun gear of the planetary gear set is connected to a compressor.

16. The variable type supercharger of claim 15, wherein an air inflow passage is connected between the compressor and the brake to supply air to the compressor.

17. The variable type supercharger of claim 13, further including a controller configured to control operation of the clutch and operation of the brake.

18. The variable type supercharger of claim 13, further including a third pulley connected to the engine, wherein a first belt is configured to couple the first pulley and the second pulley and a second belt is configured to couple the first pulley and the third pulley.
